(19) United States
(12) Patent Application Publication
(10) Pub. No.: US 2016/0016142 A1
(43) Pub. Date: Jan. 21, 2016

(54) MACHINE AND METHOD FOR ACTIVATED WATER

(71) Applicant: Aaron ROTHSCHILD, Astoria, NY (US)

(72) Inventor: Aaron ROTHSCHILD, Astoria, NY (US)

(21) Appl. No.: 14/571,001

(22) Filed: Dec. 15, 2014

Related U.S. Application Data
(63) Continuation-in-part of application No. 14/334,578, filed on Jul. 17, 2014, now abandoned.

(51) Int. Cl. B01J 19/08; A01N 59/00

(52) U.S. Cl. CPC B01J 19/088; A01N 59/00; B01J 2219/0809; B01J 2219/0869; B01J 2219/0875; B01J 2219/0894

(57) ABSTRACT

The present invention generally concerns a machine that creates and infuses charged air products into a flowing water system, where a plasma discharge is not in direct contact with the flowing water but is separated from the plasma by a void volume space. The resulting activated water may be used as an industrial wash, antibacterial wash, a medicinal drink, or can be used in agriculture, e.g. for irrigation of crops or for plant or seed treatment.

### CROSS REFERENCE TO RELATED APPLICATIONS

This application is a continuation-in-part of U.S. patent application Ser. No. 14/334,578, filed Jul. 17, 2014, the entire contents of which is hereby incorporated by reference.

### FIELD OF INVENTION

The present invention generally concerns a machine and method for creating activated water.

### BACKGROUND OF THE INVENTION

As one of our most important resources, water has a wide range of uses, including but not limited to: drinking, recreational swimming, a component or carrier for cleaning solutions and disinfectants, and for watering plants and the irrigation of crops. Sometimes sanitized water can contain bacteria that cause sickness and disease in humans, animals, and plants. Bacteria found in drinking, water can lead to waterborne diseases such as giardiasis and cryptosporidiosis.

It is known within the art that direct electrolysis or plasma induction of water produces chemically enhanced or activated water. When applied to plants, activated water improves crop growth and yield. It is suggested that atmospheric nitrogen (which is diatomic, and therefore not in a form that is immediately usable in the metabolic process of the plants) is instead broken into nitrates and free monatomic nitrogen and are associated with the “treated” water, thereby transforming the nitrogen into a state that is readily usable in plant metabolic activity.

In the medical field, sterilized medical instruments may still have or be contaminated with traces of bacterial cells, which could cause complications during surgery and slow a patient's healing process However, water's natural state prohibits its use as a standalone anti-bacterial. Water molecules naturally exist either as mono-molecular or as clusters that reduce its effective use as an anti-bacterial, but water with charged ions has enhanced properties including surfactant like qualities to attract dirt and an increased antibacterial effect. This is due to electrically-charged water having an altered chemical structure that leads to a reduction in cluster size, a reduction in pH, and the formation of oxygenated or nitro derivatives.

U.S. Pat. No. 7,291,314 to Paskalov et al. describes an apparatus that directly subjects water to RE plasma waves. This creates activated water having cluster sizes below about 4 molecules per cluster, with a pH below 4 or above 10, or water having ORP of less than −350 mV or more than +800 mV. The basic frequency of the e plasma is preferably between 0.44 MHz and 40.68 MHz, and the plasma is preferably modulated at a frequency between 10 kHz and 34 kHz. Flow rates typically range from 20 l/hr to about 2,000 1/hr.

The present invention discloses an alternative to direct electrolysis or plasma discharge of water for creating activated water. The present invention is a machine that infuses charged air species into a flowing water system, which creates activated water having enhanced anti-bacterial effects.

### SUMMARY OF THE INVENTION

These and other advantages for creating activated water by infusing charged reactive species in a gaseous state into water arc provided in the present invention. One aspect of the present invention includes a machine for creating activated water that includes a housing connected to earth or other electrical ground, a digital interface, and various power supplies; an air pump that introduces and directs air through a plasma chamber for ionization; a water pump that introduces and directs water through a water reservoir; a plasma chamber that disassociates air molecules into charged reactive species; a void volume space near the plasma chamber; and a water reservoir with an untreated water inlet, an activated water outlet, and an Archimedes screw or other mixing device for mixing the water.

It is an aspect of the present invention wherein the plasma chamber includes two concentric electrodes connected to a power supply, wherein the concentric electrodes are surrounded by a wire mesh cage, and the electrodes experience a potential sufficient enough to ionize and discharge compressed air, thereby forming various charged air products.

Another aspect of the present invention includes a plasma chamber that hovers directly over or in close proximity to a water reservoir.

Another aspect of the present invention includes electrical discharges from the plasma not being in direct contact with any water that is in or near the top of the water reservoir.

Yet another aspect of the present invention includes the water reservoir having an untreated water inlet that flows into a container having an Archimedes screw or other mixing device for mixing the water at its bottom and an activated water outlet.

Another aspect of the present invention includes the void volume space being an empty area just below the plasma chamber an just above the water reservoir, wherein the space serves as a volume for charged reactive species to congregate at the air/water interface at the top of the water reservoir, and wherein the space serves as a distance to ensure that there arc no aberrant discharges from the plasma chamber to directly electrolyze any water in the reservoir.

Another aspect of the present invention includes the activated water being formed by an Archimedes screw or other mixing device agitating the water flowing into the reservoir thereby pulling charged. reactive species at the air/water interface into the liquid to chemically alter untreated water into activated water.

Another aspect of the present invention includes the activated water being used for industrial, agricultural, or medicinal purposes.

Yet another aspect of the present invention includes a method for creating activated water comprising the construction of a housing connected to earth or other electrical ground, a digital or analog interface, and the use of various power supplies; pumping air into and through a plasma chamber for ionization; pumping water into and through a water reservoir; disassociating air molecules into charged reactive species via a plasma chamber; creating a void volume space between the plasma chamber and the water reservoir; and having a water reservoir with an untreated water inlet, an activated water outlet, and an Archimedes screw or other mixing device to agitate and mix charged reactive species at the air/water interface just above the reservoir, thereby creating activated water at the water outlet.

Another aspect of the present invention includes an air pump that creates a force that presses the charged reactive species out the plasma chamber, into the void volume space, and into the liquid in the water reservoir.

Another aspect of the present invention includes the plasma generator being a vortex type, an arc type, a DBD type, a spark gap type, a node type, and/or a grid type plasma generator and may be RE in nature.

### BRIEF DESCRIPTION OF THE DRAWINGS

FIG. 1 is a block diagram of a water activation machine, in accordance with an embodiment of the present invention.

FIG. 2 is a cross-sectional view of an activated water machine in accordance with an embodiment of the present invention.

### DETAILED DESCRIPTION OF THE INVENTION

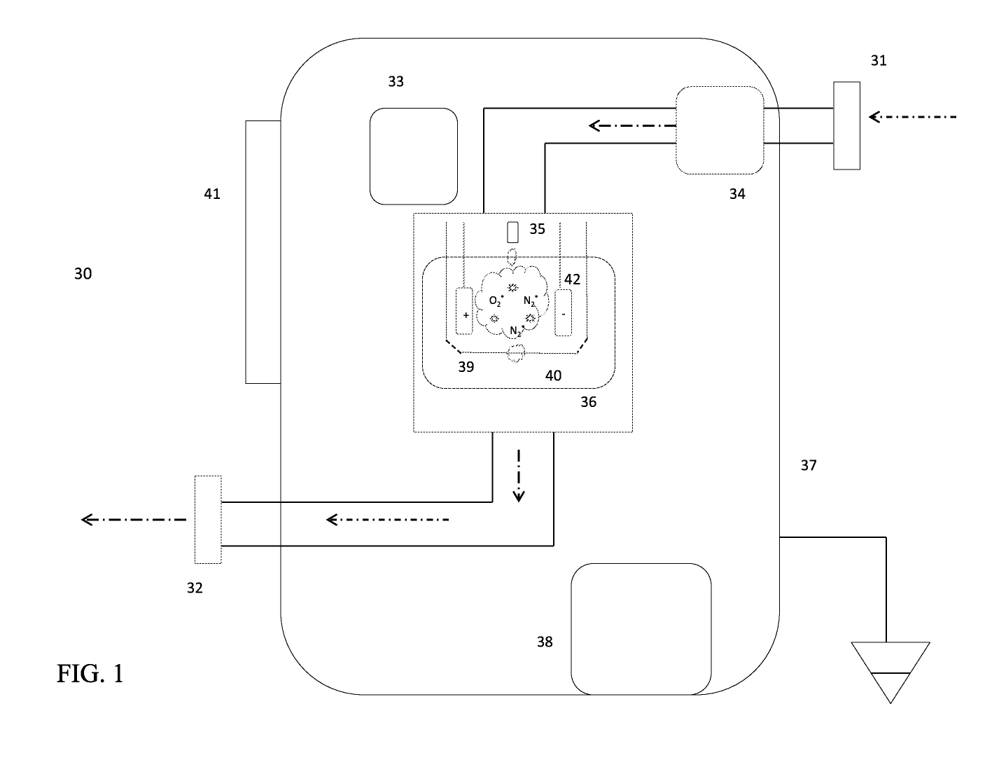

From this point forward, the following words give a detailed description of the present invention. However, these words are not a limitation on the scope of the present invention, but they are shared to illustrate certain embodiments thereof. The present invention discloses a machine that infuses charged reactive air products into a flowing water system to create activated water. FIG. 1 shows a block schematic of the invention 30 having a housing 37 that has a water inlet 31, a water reservoir 36, and an activated water outlet 32. The housing. 37 is connected to earth or other electrical ground. Resting above the reservoir 36 is a plasma chamber 39 having two concentric electrodes 42 with a fixed void space between them, a compressed air inlet 35, and a discharge screen 40. Tangential ports for air direction are not shown. The block schematic also shows a power supply 38, a digital control 41, a water pump 34, and an air pump 33.

The housing 37 dimensions may be, for example, about 30″ wide×about 24″ long×about 24″ high (and these dimensions may be smaller or larger, as desired), and may weigh up to about 300 lbs or other suitable weight. A line voltage of about 110 VAC at 60 Hz, or another suitable line voltage, is applied across the external electrodes 42. However, these numbers are flexible to include power sufficient enough to achieve RE plasma discharge in the void space between the two concentric electrodes 42.

Unit internal power separation may be utilized to separate a single phase 240 VAC or other suitable input voltage into three power circuits. A 120 VAC or other suitable voltage may be applied to the air compressor 33 and internal cooling fans (not shown). Another 120 VAC or other suitable voltage may be applied to microprocessors and for digital and/or analog control of the machine. A NEMA 10-30R or other suitable socket or receptacle is associated with the housing 37 and accepts an 8 ft. long power cord, or of another suitable length, provided with NEMA 10-30P or other suitable type of plugs on both ends.

The air pump 33 compresses and directs ambient air at about 7 SCFM to about 14 SCFM, or at another flow rate, into the void space between the concentric electrodes 42 for plasma discharge and pushes the resulting charged air products into a void space just above the water reservoir 36. Inlet 35 air pressure may range from about I atm to about 0.78 atm, or another suitable pressure, corresponding to between sea level and an altitude of about 6,500 feet. Inlet 35 air temperature may range from about 32° F. to about 105° F. to comply with OSHA regulations concerning emitted gases, or another temperature. Vented ambient air can also be used for cooling the machine 30. Generated sound may be less than 85 dBA, and, when in RF radiation may be below FCC OSHA established safety limits, or other suitable applicable limits.

Plasma Chamber and Air Ionization

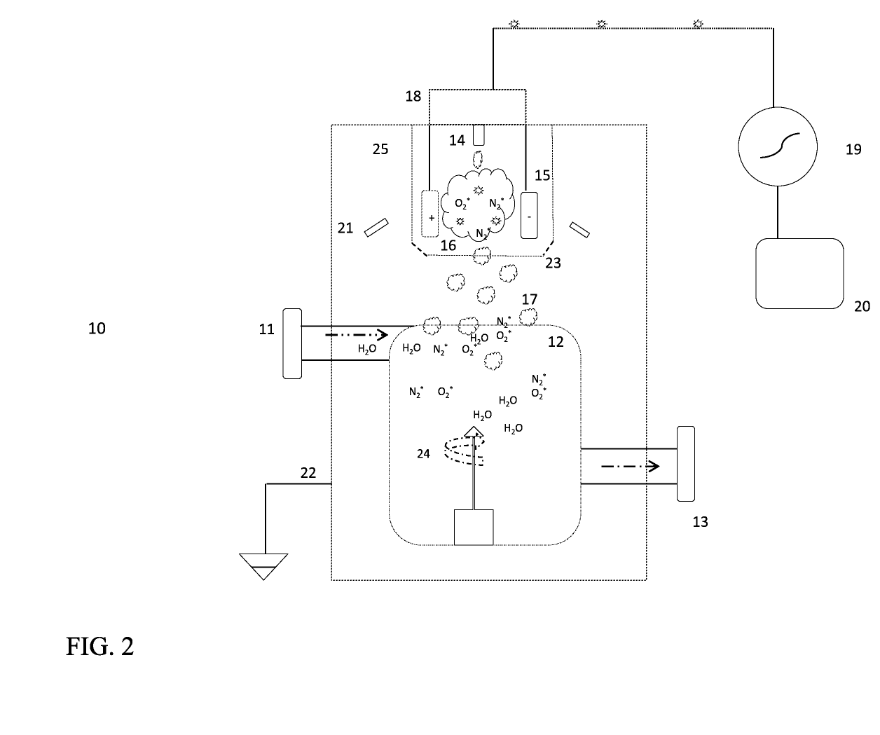

From FIG. 2, air discharge is achieved by a vortex plasma chamber 23. However, within the scope of the present invention, plasma discharge may also be achieved by a vortex, grid, spark gap, node, arc, and/or DBD type plasma generators and may be RF in nature. AC power supply 19, 20 imposes a voltage across the two electrodes 15. The potential is sufficient to create a discharge in the slightly ionized air 14 that flows from a compression pump and into a void space between the two electrodes 15.

Additional air is intentionally injected through a series of tangential ports 21 within the machine 10 to induce a vortex plasma 16, pushing the discharge around the electrodes' surface in a spiral motion. The resultant plasma 16 is an unstable capacitive discharge, where the spiral discharge goes through a cycle of formation, growth and movement, breaking, and forming of the next electrical discharge. The origin and termination points on the two electrodes 15 continuously vary as compressed air 14 flows through the device. The motion of the discharge provides for an increased residence time for the volume of compressed air 14 flowing about the plasma chamber 23.

A combination of the convective thermal properties of the plasma 16, the surface characteristics of the electrodes 15, and the force of the compressed air 14 delivered to the machine 10 results in this constant motion about the plasma chamber 23e This motion is desirable in that the high temperature discharge, which is in the presence of oxygen, results in oxidation and localized melting of the electrodes 15, resulting in electrode 15 wear. By inducing the movement of the arc across both electrode 15 surfaces, this wear can be evenly distributed.

Void Volume Space

As shown in FIG. 2, void volume space 17 may be an empty area just below the plasma chamber 23 and just above the water reservoir 12, wherein the space 17 serves as a volume for charged air products to congregate at the air/water interface at the top of the water reservoir 12, and wherein the space 17 provides sufficient distance to ensure that there are no aberrant discharges from the plasma chamber 23 to directly electrolyze any water in the reservoir 12.

The electrodes 15 are also surrounded by a wire mesh cage 25 to provide a path for aberrant electrical strikes, In an embodiment of the present invention, the void volume space 17 is at an adjustable distance such that the plasma chamber 23 hovering over the reservoir 12 does not directly electrolyze the water. Swirling outlet ionized air 17 and charged air products flow into the top of the reservoir 12 at a maximum of about I SCFM to about 14 SCFM, or at another suitable flow rate, make contact with the water surface, and flow across the surface of the water reservoir 12, Note that the water surface (when reservoir 12 has a diameter of about 10 inches to about 12 inches and is full) is only about 1 or 2 inches from the void volume space 17.

The plasma 16 discharge disassociates air, being mostly oxygen (O₂), nitrogen (N₂), argon (An, carbon dioxide (CO₂), and water (H₂O) molecules into reactively charged products, which may include monatomic oxygen, monatomic nitrogen, hydroxyl (OH⁻) ions, or H⁺ ions. These charged products recombine through numerous reactions to create gaseous molecules that may include nitrates, nitrites, ozone, and others. The pump that delivers the compressed air 14 through the inlet creates an air stream that flows through the plasma vortex 16 and pushes the resulting charged air products into an area just above the air/water interface of the water reservoir.

The duration during which the plasma 16 is present, or the flow rate of air 14 through the plasma chamber 23, or adding additional plasma devices, may result in increasing the quantity of reactive species which are generated. Through these approaches, and/or by increasing the resonance time during which the water is exposed to the species created by the plasma 16, it may be possible to increase the level of “treatment” attained. Also, it is possible that activated water may be diluted by mixing with additional water prior to industrial, medicinal, or agricultural applications.

Water Inlet, Reservoir, and Activated Water Outlet

Again referring to FIG. 2, charged air products resulting from the plasma 16 discharge are directed into a volume void space 17 immediately above a water reservoir 12 containing an untreated water inlet 11 and a water outlet 13 for activated water. An Archimedes screw 24 or mixing device for mixing the water and charged gases is located at the bottom of the reservoir 12. Within the scope of the present invention, the charged air products may also be mixed with the untreated water via micro-bubbling. There is a finite resonance time during which the water and these species are allowed to interact through the gas/water interface and at certain volumes within the water reservoir 12 until conversion to activated water is appreciable.

During reservoir 12 filling, untreated water flows via inlet 11 into the top of the reservoir 12 at a rate from about 2 gal/min to about 10 gal/min, or at another suitable flow rate, and travels through the void volume space 17 above the reservoir 12. In addition, the water flow through inlet 11 agitates the water surface and may influence mixing of the charged air product s with water to form activated water.

The inlet 11 water may be city tap water, well water, spring water, surface water, or water from another source. The inlet 11 water pressure may be about 20 psig to about 90 psig, 30-70 psig, or another suitable pressure. The inlet 11 water temperature may be about 32° F. to about 105° F., or another suitable temperature. The untreated inlet 11 water may have a total density of suspended solids of less than 100 mg/l. Microbial content heterotrophic plate count should be from about <10,000 CFU/mL average to about <20,000 CFU/mL peak. The inlet 11 system may be provided with a female garden hose water fitting.

Having an Archimedes screw 24 or other mixing device at the bottom of the reservoir 12 agitates the water and creates a suction that pulls charged air products from the void volume space 17 into the liquid at the air/water interface located at the top of the reservoir 12. The agitation dissolves the many charged gaseous molecules into the water to promote chemical reactions. This interaction changes the bonding properties of water clusters and promotes chemical reactions with impurities or additives within the water. Depending on interaction times, activated water will have a lower more acidic pH, a significant amount of oxidizing species such as H₂O₂, NO₃⁻, NO₂⁻, and the like.

Activated water outlets from the machine 10 at a rate of about 2 gal./min to about 10, or up to 50 gal./min, or at another suitable flow rate. The activated water outlet 13 pressure may range from about 30 psig to about 50 psig, or another suitable pressure. The activated water outlet 13 may have a temperature from about 32° F. to about 120° F. The outlet system 13 may be provided with a male garden hose or other suitable water fitting.

A drain may be associated with the water reservoir 12 and an actuated valve at the water inlet 11 or the activated water outlet 13 with backflow protection. Additionally the machine 10 is configured to route recirculated water (drawn from the reservoir 12 bottom) through the pump and discharge the recirculation to the top of the reservoir 12 (with discharge configuration similar to that of initially filling reservoir 12). Recirculation flow can be set from 0 gal/min to about 8 gal./min, or another suitable rate. Following activation of the water and after a finite resonance time within the reservoir 12, the activated water is removed from the reservoir 12 via an outlet 13 channel for use in agricultural, medicinal or industrial applications.

Instrumentation and Controls

Referring to FIG. 1, the machine 30 may include a digital control 41 that includes a computer having at least a central processing unit, a main memory for storing programs or data, and a fixed or hard disk drive unit (or nonvolatile memory), which are all coupled by a data bus. It may have data ports or other wired or wireless communications capability to connect with remote monitoring or control devices and/or for firmware and software updates.

The software for running the machine 30 may run inside Microsoft Internet Explorer, Firefox, Netscape, Opera, Safari, or any compatible web browser, where the web browser is capable of rendering DOM, CSS, Javascript, XML, XMLHttp requests, and the like. The computer may be a desktop, server, portable, hand-held, set-top, or any other desired configuration or may be wireless, WiFi, GPS, and/or other capabilities.

The computer may typically receive a number of inputs and outputs for communicating information externally. Non-limiting examples of inputs and outputs may include: a keyboard, a mouse or other pointing device, a touchpad, and/or a microphone, a display panel/monitor, and wired or wireless connectivity. The machine 30 may have on/off buttons and indicator lights to identify that machine 30 is on, and an indicator light to indicate when the RE power supply power is on. Machine 30 may also include a programmable logic controller (PLC) with panel display, multiple I/Os, and an Ethernet connection for remote programming and monitoring.

The machine 30 may also include data logging capabilities, and temperature sensors for key internal components (for example an RE power supply), or ability to connect to other controller systems and/or to other machines similar to machine 30 (in serial or parallel). The machine 30 may include a water outlet pressure sensor and an internal water level sensor. The machine 30 may be capable of generating a readout of RE power supply voltage and current, a readout of total unit runtime to date, a readout of electrode runtime to date, multiple tap points throughout unit for insertion of sensors, collection of process water and gas samples, programmable control of water level, discharge pressure, plasma chamber run duration, airflow duration, and dwell time of water and plasma products. The machine 30 may be capable of user control of activated water concentration (activated water can be diluted with untreated water in concentrations between about 20% treated and 100% treated).

The machine 30 may include devices, such as dials or switches, or digital controls to adjust the pH of the outflowing activated water; devices such as dials or switches or other analog or digital controls to adjust the amount of nitrates, nitrites, or other forms of nitrogen in the activated water; devices such as cartridges to add compounds or chemicals or other materials or molecules, such as potassium or phosphorous; a spigot to test outflow properties; power sources, such as solar power, hydroelectric energy, or alternative energy source; or a nitrogen generator or other gas generator.

The foregoing describes an embodiment of a machine and method that creates activated water by infusing charged air products into a flowing water system separated from a plasma chamber by void volume space. However, the foregoing is not a limitation on the scope of the present invention, but is written to detail certain embodiments thereof. It should be understood that changes may be made by one of ordinary skill in the art to the invention without departing from the scope of the invention. Thus, the scope of the present invention is solely defined by the following claims.

1. A machine for creating activated water comprising:
a housing connected to an electrical ground, a digital or analog interface, and a power supply;
an air pump that introduces and directs air through a plasma chamber for ionization;
a water pump that introduces and directs water through a water reservoir;
a plasma chamber that disassociates air molecules into charged air products;
a void volume space below the plasma chamber; and
a water reservoir with an untreated water inlet, an activated water outlet, and a mixing device.

2. The machine of claim 1, wherein said chamber comprises two concentric electrodes connected to a power supply to provide potential sufficient enough to ionize and discharge compressed air.

3. The machine of claim 2, wherein said chamber hovers directly over a water reservoir.

4. The machine of claim 3, wherein electrical discharges from the plasma are located so as to not be in direct contact with water that at the top of the water reservoir.

5. The machine of claim 1, wherein the reservoir comprises an untreated water inlet that flows into a container having an Archimedes screw at its bottom and an activated water outlet.

6. The machine of claim 1, wherein the space comprises an empty area below the plasma chamber and above the water reservoir.

7. The machine of claim 1, wherein the activated water is formed by an Archimedes screw or other mixing device agitating the water flowing into the reservoir thereby pulling charged reactive species at the air/water interface into the liquid to chemically alter untreated water into activated water.

8. A method for creating activated water comprising:
the construction of a housing connected to earth or other electrical ground, a digital or analog interface or control, and the use of various power supplies;
pumping air into and through a plasma chamber for ionization;
pumping water into and through a water reservoir;
disassociating air molecules into charged reactive species via a plasma chamber;
creating avoid volume space between the plasma chamber and the water reservoir; and
having a water reservoir with an untreated water inlet, an activated water outlet, and an Archimedes screw or other mixing device to agitate and mix charged reactive species at the air/water interface just above the reservoir, thereby creating activated water at the water outlet.

9. The machine of claim 1, wherein the air pump creates a force that presses the charged reactive species out the plasma chamber, into the void volume space, and into the liquid in the water reservoir.

10. The plasma chamber of claim 1, wherein the plasma generator can be of a vortex type, an arc type, a DBD type, a spark gap type, a node type, and/or a grid type and may be RF in nature.
